(19) United States
(12) Patent Application Publication
(10) Pub. No.: US 2003/0012982 A1
(43) Pub. Date: Jan. 16, 2003

(54) Thin magnetic film, method of fabricating the same and magnetic head including the same

(75) Inventor: Mikiko Saito, Tokyo (JP)

Correspondence Address: Norman P. Soloway, HAYES SOLOWAY P.C., 130 W. Cushing Street, Tucson, AZ, 85701, US

(73) Assignee: NEC CORPORATION

(21) Appl. No.: 10/190,205

(22) Filed: Jul. 3, 2002

(30) Foreign Application Priority Data
Jul. 6, 2001 (JP) 2001-206274

(51) Int. Cl. G11B 5/39

(52) U.S. Cl. 428/692

(57) ABSTRACT

A soft magnetic thin film is composed of cobalt (Co) at 40 to 70 weight percent both inclusive, nickel (Ni) at 2 to 20 weight percent both inclusive, and iron (Fe) at 15 to 40 weight percent both inclusive. The soft magnetic thin film has a film density of 7.4 grams/cc or greater.

### BACKGROUND OF THE INVENTION

1. Field of the Invention

The invention relates to a magnetic thin film, a method of fabricating the same, and a magnetic head including the same.

2. Description of thh Related Art

As data has been magnetically recorded at a higher density and at a higher rate, a magnetic head mounted on a magnetic disc has been required to produce a steeper magnetic field having a greater intensity.

In order to produce a high magnetic field for writing data into a magnetic disc, an upper magnetic layer or upper and lower magnetic layers in an inductive head device has to be composed of a magnetic material having high saturation magnetic flux density. In addition, such a magnetic material is necessary to be readily magnetized by flowing a current through a data-writing coil. To this end, the magnetic material has to have small coercive force and high magnetic permeability, that is, the magnetic material has to have superior soft-magnetic characteristics.

The above-mentioned upper and lower magnetic layers in an inductive head device have been conventionally composed of a nickel-iron alloy film called “permalloy” having a magnetic strain constant of almost zero and containing nickel at about 82% (hereinafter, such permalloy is referred to as “82 permalloy”). The 82 permalloy has a saturation magnetic flux density of about 10,000 gauss. A magnetic head composed of a magnetic material having a saturation magnetic flux density higher than 10,000 gauss would accomplish a steeper magnetic head producing a magnetic field having a greater intensity for writing data into a magnetic disc.

For instance, Japanese Unexamined Patent Publication No. 2-68906 (A) has suggested a magnetic head including a ternary plating film in order to accomplish a high saturation magnetic flux density.

Saturation magnetization in a ternary CoNiFe film is suggested by Bozorth as illustrated in FIG. 2.

In FIG. 2, saturation magnetization is shown in association with a composition ratio among Co, Ni and Fe. As is obvious in FIG. 2, a saturation magnetic flux density of a ternary plating film is dependent on a composition ratio of nickel (Ni). Specifically, it is necessary to reduce a composition ratio of nickel as much as possible in order to accomplish a high saturation magnetic flux density.

In contrast, it would be necessary to increase a concentration of nickel in order to have a face centered cubic (fcc) crystal structure having small magnetic strain and superior soft-magnetic characteristic.

Japanese Patent No. 2821456 (B1) has suggested a ternary CoNiFe plating film having a saturation magnetization of 2.0 tesla (T) or greater, and further suggested a magnetic head including the ternary CoFiNe plating film. The suggested ternary CoFiNe plating film contains nickel at about 10 weight percent, and contains no additives such as saccharin, ensuring a boundary between a face centered cubic (fcc) crystal structure and a body centered cubic (bcc) crystal structure is shifted to a structure containing nickel at a lower concentration than a conventional structure. As a result, the suggested soft magnetic film has a high saturation magnetization, a low coercive force, and small magnetic strain.

However, a saturation magnetization of a CoNiFe film as well as a coercive force and magnetic strain can be controlled not only by a composition ratio, but also by a crystal structure.

For instance, Japanese Unexamined Patent Publications Nos. 7-3489 (A) and 6-346202 (A) have suggested a soft magnetic thin film in which a face centered cubic crystal plane is preferentially aligned. Specifically, alignment of a face centered cubic lattice (200) plane relative to a (111) plane is defined for reducing both a coercive force and magnetic strain.

For instance, assuming that a peak intensity of X-ray diffraction in a face centered cubic lattice (200) plane is represented as fcc (200), a peak intensity of X-ray diffraction in a face centered cubic lattice (111) plane is represented as fcc (111), and a peak intensity of X-ray diffraction in a body centered cubic lattice (110) plane is represented as bcc (110) in a ternary CoNiFe film in Japanese Unexamined Patent Publication No. 7-3489, the Publication suggests that a relation among those peak intensities should be determined as follows.

0.1≦fcc (200)/fcc (111)≦0.2 or 0.1≦fcc (200)/fcc (111), and

bcc (110)/fcc (111)≦0.1

The above-mentioned Japanese Unexamined Patent Publication No. 6-346202 (A) has suggested that a relation among those peak intensities should be determined as follows.

fcc (200)/fcc (111)>0.25

Japanese Unexamined Patent Publication No. 2002-93620 has suggested a ternary CoNiFe film in which a relation among those peak intensities should be fcc (200)/fcc (111)<0.25 and a ratio of a peak intensity of bcc (110) to a peak intensity of fcc (111) is equal to or greater than 0.01, but equal to or smaller than 3.0.

It has been found out in the Publication that a peak intensity ratio among crystal structures is an important factor exerting serious influence on saturation magnetization of a film. That is, saturation magnetization would be higher in a film containing bcc crystal structure in a larger volume than fcc crystal structure, because bcc crystal structure has a higher magnetic moment than that of fcc crystal structure. In order for a film to much contain bcc crystal structure, a composition ratio of iron might be set higher. As an alternative, a crystal structure may be altered in dependence on conditions for depositing a film.

Japanese Unexamined Patent Publication No. 2002-93620 is explained here only for the purpose of better understanding of the present invention. The reference to Japanese Unexamined Patent Publication No. 2002-92620 does not mean that the applicant admits that the Publication constitutes statutory prior art to the present invention.

Japanese Unexamined Patent Publication No. 3-248507 (A) has suggested a soft magnetic alloy film composed of (FexCoy)aMbCc, in which “M” indicates at least one of Ti, Zr, Hf. V, Nb, Ta, Mo and W, “x” and “y” indicate a ratio defined as follows:

0.25≦x≦0.87; 0.13≦y≦0.75; and x+y=1,

and “a”, “b” and “c” indicate atom percent defined as follows:

50%≦a≦96%; 2%≦b≦39%; 0.5%≦c≦25%; and a+b+c=100%.

The above-mentioned metals contain crystal particles having an average diameter of 0.8 micrometers or smaller, and contains crystal phase of carbide of the element M as a part of crystal particles.

Japanese Unexamined Patent Publication No. 10-199726 (A) has suggested a soft magnetic thin film composed of CoNiFe alloy containing Co at 30 to 90 atom percent, Ni at 40 atom percent or below, Fe at 40 atom percent or below, and S at 0.5 to 4 atom percent.

With an increase in a density at which data is magnetically recorded, there is an increasing demand for a magnetic head having high capacity of recording data. In order to such a magnetic head, many suggestions have been made with respect to composition and/or crystal structure of a ternary CoNiFe magnetic thin film having high saturation magnetization and superior soft-magnetic characteristics.

What is important above all in development of a magnetic material of which such a magnetic head as mentioned above is composed is to be able to much supply a material having desired characteristics. To this end, it is necessary to analyze not only a composition and crystal structure, but also mechanism of formation of a magnetic film as well as conditions for depositing a magnetic film.

FIG 3 shows a relation between a ratio of a peak intensity fcc (111) of X-ray diffraction to a peak intensity bcc (110) of X-ray diffraction, and saturation magnetization. As observed by a sample marked “fix”, it has been confirmed that there could be obtained a magnetic film having saturation magnetization remarkably lower than the same of other sample, even though they have a common peak intensity ratio. As mentioned later, such a magnetic film is caused by a film density. Specifically, it has been found out that a magnetic film having a smaller film density would have smaller saturation magnetization.

### SUMMARY OF THE INVENTION

In view of the above-mentioned problems in the conventional magnetic thin film, it is an object of the present invention to analyze a relation between saturation magnetization and a film density, and a relation between a coercive force and a diameter of particles contained in a magnetic thin film, and find conditions for plating a film for accomplishing desired characteristics of a magnetic thin film, to thereby provide a soft magnetic thin film having a small coercive force, a small magnetic strain constant, and high saturation magnetization in the range of 18,000 to 23,000.

It is also an object of the present invention to provide a method of fabricating such a soft magnetic thin film.

It is further an object of the present invention to provide a magnetic head including such a soft magnetic thin film.

In one aspect of the present invention, there is provided a soft magnetic thin film composed of cobalt (Co) at 40 to 70 weight percent both inclusive, nickel (Ni) at 2 to 20 weight percent both inclusive, and iron (Fe) at 15 to 40 weight percent both inclusive, the soft magnetic thin film having a film density of 7.4 grams/cc or greater.

There is further provided a soft magnetic thin film composed of cobalt (Co) at 40 to 70 weight percent both inclusive, nickel (Ni) at 2 to 20 weight percent both inclusive, and iron (Fe) at 15 to 40 weight percent both inclusive, the soft magnetic thin film containing particles having a diameter in the range of 5 nm to 100 nm both inclusive.

In another aspect of the present invention, there is provided a method of fabricating a soft magnetic thin film composed of cobalt (Co) at 40 to 70 weight percent both inclusive, nickel (Ni) at 2 to 20 weight percent both inclusive, and iron (Fe) at 15 to 40 weight percent both inclusive, the soft magnetic thin film having a film density of 7.4 grams/cc or greater, the method including the step of fabricating the soft magnetic thin film through the use of chloride bath in a plating solution containing cobalt ion at 0.03 to 0.4 mols/liter, nickel ion at 0.03 to 0.2 mols/liter, and iron ion at 0.003 to 0.15 mole/liter.

There is further provided a method of fabricating a soft magnetic thin film composed of cobalt (Co) at 40 to 70 weight percent both inclusive, nickel (Ni) at 2 to 20 weight percent both inclusive, and iron (Fe) at 15 to 40 weight percent both inclusive, the soft magnetic thin film containing particles having a diameter in the range of 5 nm to 100 nm both inclusive, the method including the step of fabricating the soft magnetic thin film through the use of chloride bath in a plating solution containing cobalt ion at 0.03 to 0.4 mols/liter, nickel ion at 0.03 to 0.2 mols/liter, and iron ion at 0.003 to 0.15 mols/liter.

There is still further provided a method of fabricating a soft magnetic thin film composed of cobalt (Co) at 40 to 70 weight percent both inclusive, nickel (Ni) at 2 to 20 weight percent both inclusive, and iron (Fe) at 15 to 40 weight percent both inclusive, the soft magnetic thin film having a film density of 7.4 grams/cc or greater, the method including the step of fabricating the soft magnetic thin film in a plating solution containing cobalt ion at 0.03 to 0.4 mols/liter, nickel ion at 0.03 to 0.2 mols/liter, and iron ion at 0.003 to 0.15 mols/liter in electrolytic plating condition by which an overvoltage can be increased.

There is yet further provided a method of fabricating a soft magnetic thin film composed of cobalt (Co) at 40 to 70 weight percent both inclusive, nickel (Ni) at 2 to 20 weight percent both inclusive, and iron (Fe) at 15 to 40 weight percent both inclusive, the soft magnetic thin film containing particles having a diameter in the range of 5 nm to 100 nm both inclusive, the method including the step of fabricating the soft magnetic thin film in a plating solution containing cobalt ion at 0.03 to 0.4 mols/liter, nickel ion at 0.03 to 0.2 mols/liter, and iron ion at 0.003 to 0.15 mols/liter in electrolytic plating condition by which an over-voltage can be increased.

For instance, the electrolytic plating condition may include using a sulfuric plating bath having pH equal to or greater than 2.2, but smaller than 3.3.

As an alternative, the electrolytic plating condition may include using a sulfuric plating bath kept at 20 degrees centigrade or smaller.

In still another aspect of the present invention, there is provided a magnetic head including a magneto-resistance device for reproducing data and an inductive head device for storing data therein, the inductive head device including an upper magnetic pole and a lower magnetic pole, the upper and lower magnetic poles being composed at least partially of a soft magnetic thin film composed of cobalt (Co) at 40 to 70 weight percent both inclusive, nickel (Ni) at 2 to 20 weight percent both inclusive, and iron (Fe) at 15 to 40 weight percent both inclusive, the soft magnetic thin film having a film density of 7.4 grams/cc or greater.

There is further provided a magnetic head including a magneto-resistance device for reproducing data and an inductive head device for storing data therein, the inductive head device including an upper magnetic pole and a lower magnetic pole, the upper and lower magnetic poles being composed at least partially of a soft magnetic thin film composed of cobalt (Co) at 40 to 70 weight percent both inclusive, nickel (Ni) at 2 to 20 weight percent both inclusive, and iron (Fe) at 15 to 40 weight percent both inclusive, the soft magnetic thin film containing particles having a diameter in the range of 5 nm to 100 nm both inclusive.

The advantages obtained by the aforementioned present invention will be described hereinbelow.

In accordance with the present invention, a magnetic thin film is designed to contain particles having a diameter in the range of 5 to 100 nm, and resultingly, has a film density of 7.4 grams/cc or greater. This ensures much supply of a CoNiFe film having high saturation magnetization of 18,000 G. By applying the magnetic thin film to a magnetic head, it would be possible to much supply a magnetic recorder having a high recording density.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a graph showing a relation between a film density and saturation magnetization.

FIG. 2 shows a relation between a composition and saturation magnetization in a ternary CoNiFe film.

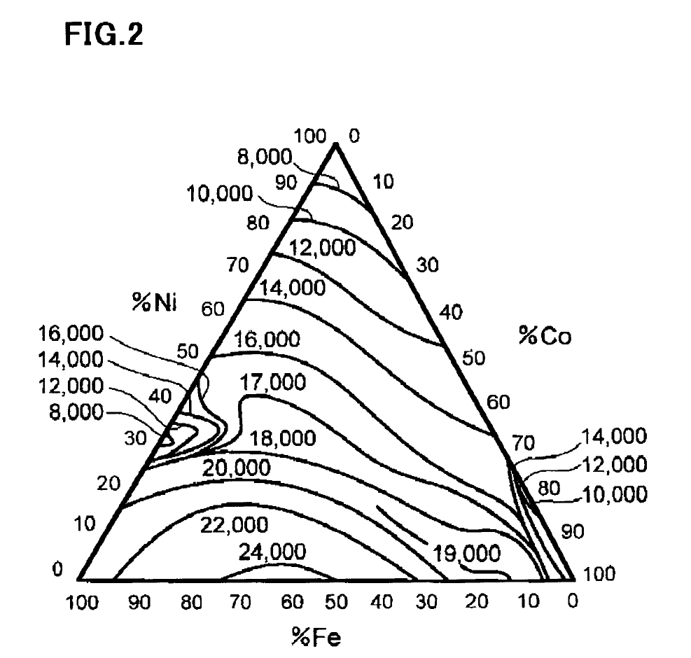

FIG. 3 is a graph showing a relation between a peak intensity ratio and saturation magnetization.

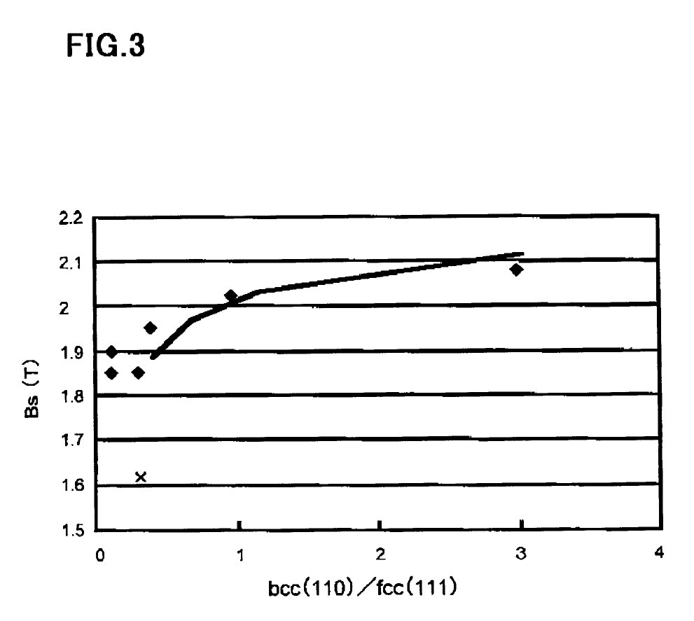

FIG. 4 is a graph showing a relation between a diameter of particles and a coercive force in a CoNiFe film.

FIG. 5 is a graph showing a relation between Fe composition obtained through the use of a plating bath, and saturation magnetization.

FIG. 6 is a graph showing a relation between a temperature of a plating bath and an over-voltage.

FIG. 7 is a graph showing a relation between pH of a plating bath and an over-voltage.

FIG. 8 is a graph showing a relation between pH of a plating bath and saturation magnetization.

FIG. 9 is a graph showing a relation between a mol-concentration of metal ions in a plating bath and an over-voltage.

FIG. 10 is a partial cross-sectional view of a magnetic head including the soft magnetic thin film in accordance with the present invention.

### DESCRIPTION OF THE PREFERRED EMBODIMENTS

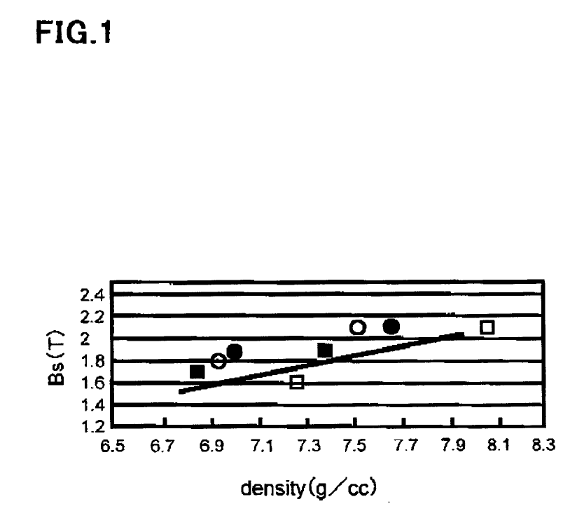

FIG. 1 is a graph showing a relation between a film density [grams/cc] and saturation magnetization Bs [T] in a CoNiFe film, obtained by Rutherford back-scattering (RBS). FIG. 1 shows a plurality of measurement results obtained by testing sample CoNiFe films having composition ratios in which Co is in the range of 50 to 70 atom percent, Ni is in the range of 7 to 13 atom percent, and Fe is in the range of 20 to 33 atom percent. In FIG. 1, samples having the same composition are represented with the same mark.

As is obvious if the samples having the same composition are compared to one another, it is understood that a film having a higher film density has higher saturation magnetization.

It is also understood that it is possible to accomplish high saturation magnetization of 1.8T or greater by designing a film density equal to or higher than 7.4 grams/cc. Since a film having a low film density much contains impurities such as hydrogen or oxygen, one of factors for accomplishing a high film density is to reduce impurities in a film as much as possible.

It has been experimentally confirmed that a preferred content range of Co, Ni and Fe in a soft magnetic thin film are in the range of 40 to 70 weight percent, 2 to 20 weight percent, and 15 to 40 weight percent, respectively.

The inventor had measured diameters of samples in which a difference in a film density was observed, but a difference in film unpurity was not observed. The diameters were measured by means of a transmission type electron scope. It was found out that the sample having a high film density contains not only particles having a great diameter, but also particles having a small diameter. It was also found out that a high film density could be obtained in an area where particles having a diameter of 20 nm or greater existed, in a mixed-crystal area of fcc and bcc.

A film not composed of mixed crystal, such as a Co₇₆Ni₁₀Fe₁₄ film, has a single-layered structure including a fcc layer, contains particles having a diameter of 100 nm or greater, and has a coercive force of 10 Oe or greater. If a coercive force is too high, it would suppress movement of magnetic domain and cause Barkhausen noise. Hence, a coercive force is required to be equal to or smaller than 2 Oe. The film has small saturation magnetization of 1.7 tesla (T) or smaller, and hence, is considered not suitable to a material of which a high density recording medium is composed, because such a recording medium requires high saturation magnetization.

As G. Herzer reported in IEEE Trans. Mag. 1990, a film containing particles having a larger diameter would have a higher coercive force (Hc).

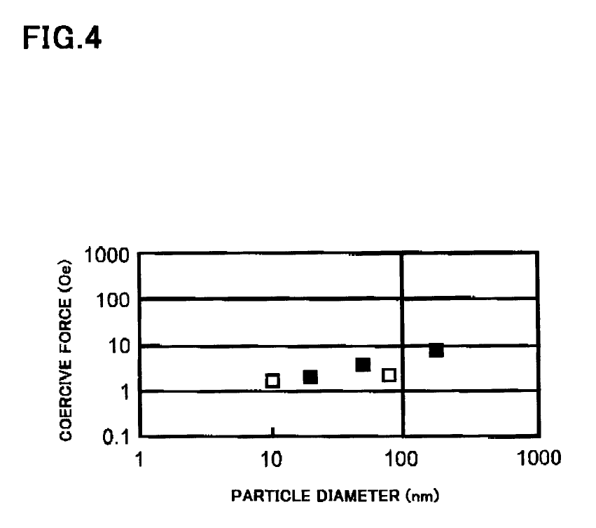

FIG. 4 shows a relation between a diameter of particles and a coercive force in a CoNiFe film formed in accordance with the present invention.

In the CoNiFe film formed in accordance with the present invention, a larger diameter of particles is associated with a higher coercive force. However, a coercive force of the CoNiFe film is not in proportion to the sixth power of a diameter of particles unlike the G. Herzer's report. Since the CoNiFe film contains not only particles having a small diameter, but also particles having a great diameter, the CoNiFe film has a small coercive force. Specifically, even if the CoNiFe film contains particles having a diameter of about 100 nm, the CoNiFe film had a coercive force of about 2 Oe. Accordingly, it was confirmed that a coercive force could be equal to or smaller than 2 Oe, if a diameter of particles contained in a CoNiFe film is arranged in the range of 5 to 100 nm.

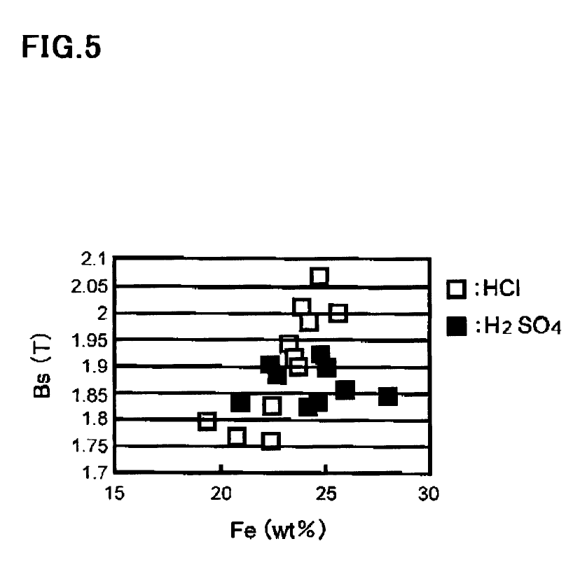

FIG. 5 shows a relation between Fe composition obtained through the use of chloride and sulfuric acid plating bath, and saturation magnetization.

It was observed that a sample film containing Fe at 23 weight percent or greater had increasing saturation magnetization among sample films formed through the use of a HCl plating bath.

Because of the fact that the same iron composition could not be obtained unless Fe ions were increased in a chloride plating bath in comparison with a sulfuric acid plating bath, irregular eutectoid was not likely to occur, that is, production of hydrogen at an interface was suppressed, and hence, FeOH⁺ causing irregular eutectoid was unlikely to be generated.

In other words, there progresses a plating process in which ions are absorbed at a surface of a film, discharge, and turn into metal atoms. This ensures a high current efficiency in association with a thickness of the film.

An example of a plating bath is shown in Table 1. The film formed through the use of a plating bath shown in Table 1 had superior magnetic characteristics.

TABLE 1

| Chemical | Content [mol/liter] |
|---|---|
| Cobalt Chloride | 0.091 |
| Nickel Chloride | 0.20 |
| Ammonium Chloride | 0.28 |
| Boric Acid | 0.40 |
| Ferrous Chloride (FeCl₂) | 0.0180 |
| Sodium Dodecyric Acid | 0.00035 |

(Conditions) Current Density: 15.0 mA/cm², pH: 2.5

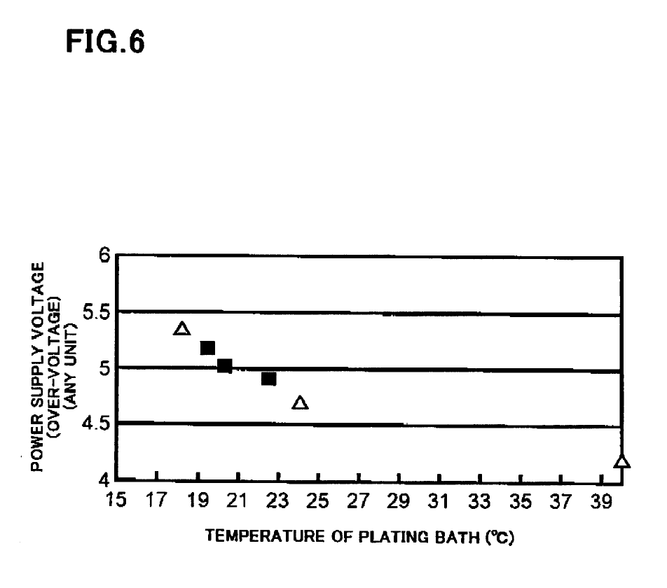

FIG. 6 is a graph showing a relation between a power supply voltage or an overvoltage and a temperature of a plating bath in a plating unit in which a constant current is applied to both an anode and a cathode.

It is understood in view of FIG. 6 that if a temperature of a plating bath lowers, a power supply voltage or an over-voltage increases. It was confirmed that an increased over-voltage caused an increase in a current efficiency and enhancement in a film density.

FIG. 6 is a graph showing a relation between a power supply voltage or an over-voltage and pH of a plating bath in a plating unit in which a constant current is applied to both an anode and a cathode.

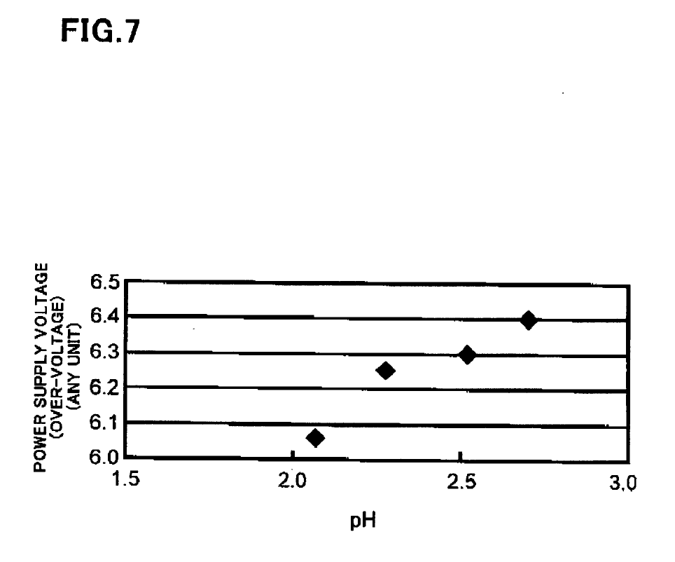

It is understood in view of FIG. 7 that if pH of a plating bath raises, a power supply voltage or an overvoltage increases. It was confirmed that raised pH caused an increase in a current efficiency and enhancement in a film density.

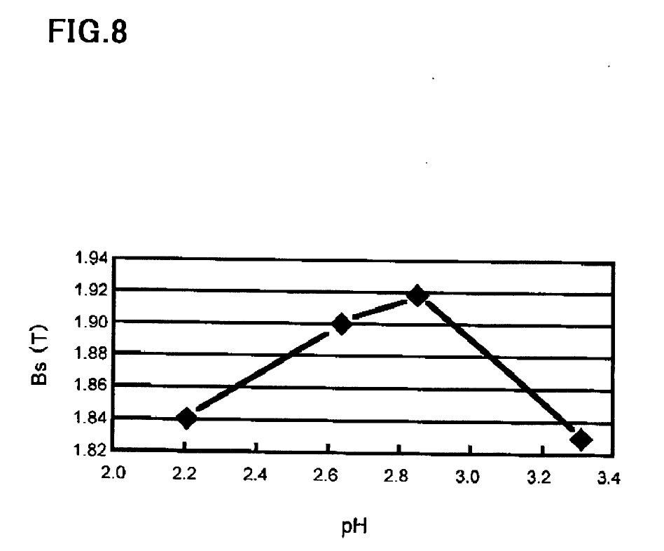

FIG. 8 is a graph of the measurement results about a relation between pH and saturation magnetization.

It is understood in view of FIG. 8 that as pH raises, saturation magnetization Bs increases, and that saturation magnetization Bs decreases, if pH is equal to or higher than about 2.9.

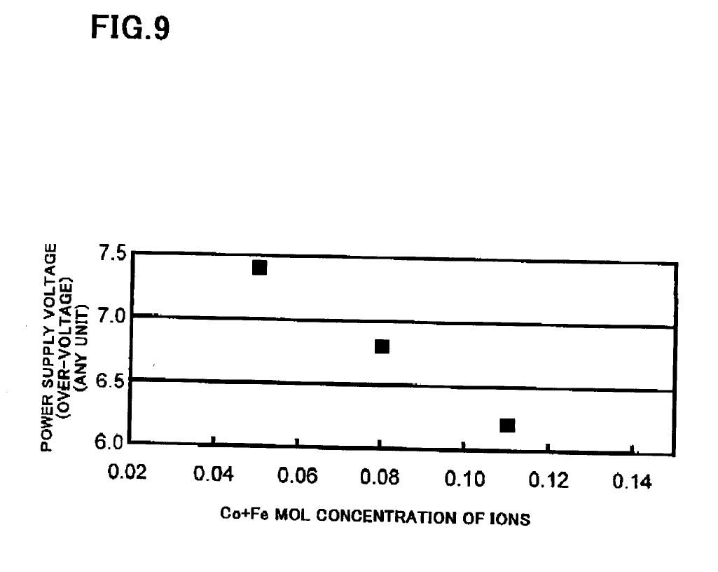

FIG. 9 is a graph of the measurement results about a relation between a mol concentration of Co, Ni and Fe ions and an over-voltage in a plating bath containing Co at 66 weight percent, Ni at 10 weight percent, and Fe at 24 weight percent.

It was confirmed that if a mol concentration was reduced, an over-voltage raised. It was also confirmed that if a mol concentration was reduced, saturation magnetization was also increased.

An example of a plating bath in a low mol concentration is shown in Table 2.

TABLE 2

| Chemical | Content [mol/liter] |
|---|---|
| Cobalt Chloride | 0.04 |
| Nickel Chloride | 0.070 |
| Ammonium Chloride | 0.28 |
| Boric Acid | 0.40 |
| Ferrous Chloride (FeCl₂) | 0.0105 |
| Sodium Dodecyric Acid | 0.00035 |

(Conditions) Current Density: 15.0 mA/cm², pH: 2.6

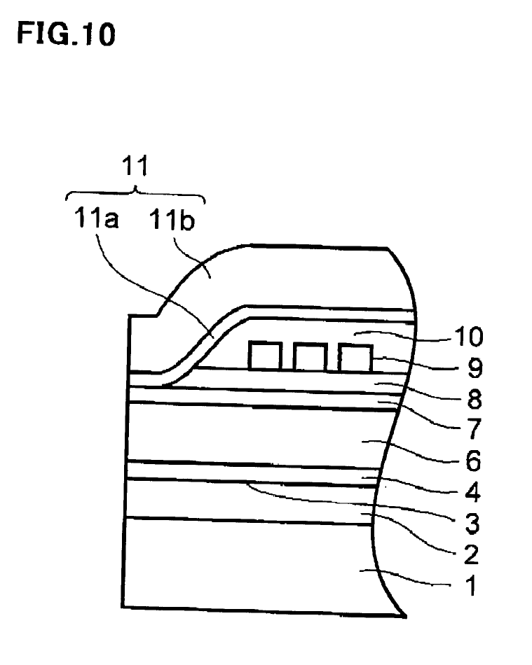

FIG. 10 is a partial cross-sectional view of a magnetic head including the magnetic thin CoFeNi film formed in accordance with the present invention.

The illustrated magnetic head is comprised of a substrate 1, a lower shield 2 formed on the substrate 1, a magnetically separating layer a formed on the lower shield 2 and composed of alumina, a magnetoresistance effect device 4 formed on the magnetically separating layer 3, an upper shield 6 formed on the magnetoresistance effect device 4, a magnetic gap 7 formed on the upper shield 6, a non-magnetic insulator 8 formed on the magnetic gap 7, a plurality of coils 9 formed on the non-magnetic insulator 8, a second non-magnetic insulator 10 covering the coils 9 therewith, and an upper magnetic pole 11 covering the magnetic gap 7, the non-magnetic insulator 8 and the second non-magnetic insulator 10 therewith.

The upper magnetic pole 11 is comprised of a first layer 11a covering the magnetic gap 7, the non-magnetic insulator 8 and the second non-magnetic insulator 10 therewith and a second layer 11b formed on the first layer 11a.

The upper shield 6 acts as a lower magnetic layer.

The magnetic thin CoFeNi film is formed by electrolytic plating on an underlying layer formed by sputtering on an electrically insulating layer.

The substrate 1 which will make a slider is composed of complex ceramic of alumina and titanium carbide.

A magnetic head having a function of reproducing data is fabricated on the substrate 1. The magnetic head is comprised of the lower shield 2, the upper shield 6 comprised of a NiFe film containing nickel at about 80 weight percent, and the magnetoresistance effect device 4 sandwiched between the lower shield 2 and the upper shield 6 with the magnetically separating layer 3 being sandwiched between the magnetoresistance effect device 4 and the lower shield 2.

The lower shield 2 has a thickness of 1 micrometer, and the upper shield 6 has a thickness of 3 micrometers. A gap between the lower shield 2 and the upper shield 6 is 0.13 micrometers. On the above-mentioned magnetic head is fabricated an ID head having a function of recording data. The ID head uses the upper shield 6 as a first magnetic pole.

The upper shield 6 acting as a lower magnetic pole has a multi-layered structure including 82 permalloy and the CoNiFe film formed in accordance with the present invention.

The magnetic gap 7 is composed of alumina and has a thickness of 0.18 micrometers. By means of the non-magnetic insulator 8 formed on the magnetic gap 7, zero-throat height is defined. The non-magnetic insulator 8 is composed of photoresist.

The coils 9 formed on the non-magnetic insulator 8 are comprised of a copper-plated film, and are electrically insulated by the second non-magnetic insulator 10. The second non-magnetic insulator 10 is composed of photoresist.

The upper magnetic pole 11 formed as a second magnetic pole and covering the second non-magnetic insulator 10 therewith is exposed to ABS facing a magnetic medium (not illustrated).

As mentioned earlier, the upper magnetic pole 11 is comprised of the first layer 11a and the second layer 11b. The first layer 11a is formed of 82 permalloy as an underlying layer by sputtering, and the second layer 11b is comprised of a CoNiFe film having saturation magnetization Bs of 2T and formed in accordance with the present invention. The upper magnetic pole 11 has a thickness in the range of 0.5 to 2.0 micrometers. The upper shield 6 as a lower magnetic pole and the upper magnetic pole 11 are formed by electrolytic plating in accordance with the present invention.

The CoNiFe film was formed on a substrate by paddling in a plating bath having the composition as shown in Table 1. The resultant CoNiFe film contained Co at 66 weight percent, Ni at 11 weight percent, and Fe at 23 weight percent, and has a specific resistance of 20 μΩ·cm.

There could be accomplished a magnetically recording unit having a recording density of about tens of gigabits/cm² or greater through the use of the magnetic head in accordance with the present invention, in which case, a recording medium had a coercive force of 3500 Oe or greater, and a magnetic gap between a recording medium and a magnetic head was 30 nm.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2001-206274 filed on Jul. 6, 2001 including specification, claims, drawings and summary is incorporated herein by reference in its entirety.

What is claimed is:

1. A soft magnetic thin film composed of cobalt (Co) at 40 to 70 weight percent both inclusive, nickel (Ni) at 2 to 20 weight percent both inclusive, and iron (Fe) at 15 to 40 weight percent both inclusive, said soft magnetic thin film having a film density of 7.4 grams/cc or greater.

2. A soft magnetic thin film composed of cobalt (Co) at 40 to 70 weight percent both inclusive, nickel (Ni) at 2 to 20 weight percent both inclusive, and iron (Fe) at 15 to 40 weight percent both inclusive, said soft magnetic thin film containing particles having a diameter in the range of 5 nm to 100 nm both inclusive.

3. A method of fabricating a soft magnetic thin film composed of cobalt (Co) at 40 to 70 weight percent both inclusive, nickel (Ni) at 2 to 20 weight percent both inclusive, and iron (Fe) at 15 to 40 weight percent both inclusive, said soft magnetic thin film having a film density of 7.4 grams/cc or greater,
said method comprising the step of fabricating said soft magnetic thin film through the use of chloride bath in a plating solution containing cobalt ion at 0.03 to 0.4 mols/liter, nickel ion at 0.03 to 0.2 mols/liter, and iron ion at 0.003 to 0.15 mols/liter.

4. A method of fabricating a soft magnetic thin film composed of cobalt (Co) at 40 to 70 weight percent both inclusive, nickel (Ni) at 2 to 20 weight percent both inclusive, and iron (Fe) at 15 to 40 weight percent both inclusive, said soft magnetic thin film containing particles having a diameter in the range of 5 nm to 100 nm both inclusive,
said method comprising the step of fabricating said soft magnetic thin film through the use of chloride bath in a plating solution containing cobalt ion at 0.03 to 0.4 mols/liter, nickel ion at 0.03 to 0.2 mols/liter, and iron ion at 0.003 to 0.15 mols/liter.

5. A method of fabricating a soft magnetic thin film composed of cobalt (Co) at 40 to 70 weight percent both inclusive, nickel (Ni) at 2 to 20 weight percent both inclusive, and iron (Fe) at 15 to 40 weight percent both inclusive, said soft magnetic thin film having a film density of 7.4 grams/cc or greater,
said method comprising the step of fabricating said soft magnetic thin film in a plating solution containing cobalt ion at 0.03 to 0.4 mols/liter, nickel ion at 0.03 to 0.2 mols/liter, and iron ion at 0.003 to 0.15 mols/liter in electrolytic plating condition by which an over-voltage can be increased.

6. The method as set forth in claim 5, wherein said electrolytic plating condition includes using a sulfuric plating bath having pH equal to or greater than 2.2, but smaller than 3.3.

7. The method as set forth in claim 5, wherein said electrolytic plating condition includes using a sulfuric plating bath kept at 20 degrees centigrade or smaller.

8. A method of fabricating a soft magnetic thin film composed of cobalt (Co) at 40 to 70 weight percent both inclusive, nickel (Ni) at 2 to 20 weight percent both inclusive, and iron (Fe) at 15 to 40 weight percent both inclusive, said soft magnetic thin film containing particles having a diameter in the range of 5 nm to 100 nm both inclusive,
said method comprising the step of fabricating said soft magnetic thin film in a plating solution containing cobalt ion at 0.03 to 0.4 mols/liter, nickel ion at 0.03 to 0.2 mols/liter, and iron ion at 0.003 to 0.15 mols/liter in electrolytic plating condition by which an over-voltage can be increased.

9. The method as set forth in claim 8, wherein said electrolytic plating condition includes using a sulfuric plating bath having pH equal to or greater than 2.2, but smaller than 3.3.

10. The method as set forth in claim 8, wherein said electrolytic plating condition includes using a sulfuric plating bath kept at 20 degrees centigrade or smaller.

11. A magnetic head including a magneto-resistance device for reproducing data and an inductive head device for storing data therein,
said inductive head device including an upper magnetic pole and a lower magnetic pole,
said upper and lower magnetic poles being composed at least partially of a soft magnetic thin film composed of cobalt (Co) at 40 to 70 weight percent both inclusive, nickel (Ni) at 2 to 20 weight percent both inclusive, and iron (Fe) at 15 to 40 weight percent both inclusive, said soft magnetic thin film having a film density of 7.4 grams/cc or greater.

12. A magnetic head including a magneto-resistance device for reproducing data and an inductive head device for storing data therein,
said inductive head device including an upper magnetic pole and a lower magnetic pole,
said upper and lower magnetic poles being composed at least partially of a soft magnetic thin film composed of cobalt (Co) at 40 to 70 weight percent both inclusive, nickel (Ni) at 2 to 20 weight percent both inclusive, and iron (Fe) at 15 to 40 weight percent both inclusive, said soft magnetic thin film containing particles having a diameter in the range of 5 nm to 100 nm both inclusive.
